(19) United States
(12) Patent Application Publication
(10) Pub. No.: US 2007/0257486 A1
(43) Pub. Date: Nov. 8, 2007

(54) Elastomeric Seal for Expandable Connector

(75) Inventors: Andrei Gregory Filippov, Houston, TX (US); Scott Anthony Benzie, Houston, TX (US); Dimitri Andrei Filippov, Houston, TX (US)

Correspondence Address: TUMEY, L.L.P., P.O. BOX 22188, HOUSTON, TX, 77227-2188, US

(73) Assignee: GRINALDI LTD., Houston, TX (US)

(21) Appl. No.: 11/741,600

(22) Filed: Apr. 27, 2007

Related U.S. Application Data
(60) Provisional application No. 60/797,325, filed on May 3, 2006.

(51) Int. Cl. F16L 13/14

(52) U.S. Cl. 285/382.2; 285/382.1; 285/382.4; 285/355

(57) ABSTRACT

A radially expandable tubular connection and methods for expansion related thereto are disclosed. In an embodiment, a radially expandable tubular connection includes a radially-expandable box member. The radially-expandable box member includes an internal thread, and a non-threaded internal area including a groove providing a mechanical means for securing position of an elastomeric seal ring disposed in the groove. The radially expandable tubular connection further includes a radially-expandable pin member. The radially-expandable pin member includes an external thread for threadably engaging the internal thread. In addition, the radially-expandable pin member includes a non-threaded external seal surface carried by an elongated pin nose for engaging the elastomeric seal ring in a sealable manner. The radially expandable tubular connection further includes radial expansion of the radially expandable tubular connection when the external thread is threadably engaged within the internal thread to produce deformation to compress the elastomeric seal ring between the pin and box members to seal an annular area between the pin and box members.

### CROSS-REFERENCE TO RELATED APPLICATIONS

This application is a non-provisional of U.S. Application Ser. No. 60/797,325 filed on May 3, 2006, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of threaded tubular connections and more specifically to radially expandable threaded tubular connections.

2. Background of the Invention

In the oil and natural gas well drilling industry, strings of tubulars of different diameters are typically placed in a wellbore for different purposes such as stabilizing a formation or protecting a borehole against elevated wellbore pressures. A conventional technology involving such strings of tubulars is “expandable technology” in which a tubular member may be plastically radially expanded in the wellbore to diameters larger than the original diameters, which may minimize the reduction in internal diameter of the ordinary telescopic well design.

Casing joints, liners and other oilfield tubulars are usually connected in an end-to-end manner by threaded connections. The connections may be designed to provide mechanical integrity between the joints and a seal between the interior and exterior of the tubular connection. Elastomeric seals are typically used as seals for expandable connectors for expandable technology. For instance, a conventional elastomeric seal may include an annular elastomeric seal ring and an annular spacer ring carried in a rectangular groove in a box member. Drawbacks to such conventional elastomeric seals include the rectangular groove not providing secure positioning of the elastomeric seal ring in the groove, which may cause problems. One such problem includes the elastomeric seal ring and the spacer ring not being secured in the groove, which may result in such rings falling out of the groove during transportation and/or connector make-up. Such rings falling out may jeopardize the reliability of the connector and expansion process. To overcome such drawbacks, the conventional elastomeric seals may not be positioned in the groove prior to transportation of the tubular and are typically installed on the rig, immediately before the connector make-up, which may increase the cost of the operation.

Conventional elastomeric seals are typically based on the initial compression (e.g., squeeze) of the elastomeric ring between fully engaged seal surfaces. Drawbacks include radial expansion of the connector causing significant displacements between seal surfaces, which may result in the conventional elastomeric seals being damaged during installation or the connectors leaking after radial expansion thereof.

Consequently, there is a need for a reliable elastomeric seal for a radially expandable threaded connection that is secure during transportation and installation. There is a further need for an elastomeric seal that is capable of providing and maintaining an internal seal for connectors expanded in various well conditions.

### BRIEF SUMMARY OF SOME OF THE PREFERRED EMBODIMENTS

These and other needs in the art are addressed in one embodiment by a radially expandable tubular connection. In an embodiment, a radially expandable tubular connection includes a radially-expandable box member. The radially-expandable box member includes an internal thread, and a non-threaded internal area including a groove providing a mechanical means for securing position of an elastomeric seal ring disposed in the groove. The radially expandable tubular connection further includes a radially-expandable pin member. The radially-expandable pin member includes an external thread for threadably engaging the internal thread. In addition, the radially-expandable pin member includes a non-threaded external seal surface carried by an elongated pin nose for engaging the elastomeric seal ring in a sealable manner. The radially expandable tubular connection further includes radial expansion of the radially expandable tubular connection when the external thread is threadably engaged within the internal thread to produce deformation to compress the elastomeric seal ring between the pin and box members to seal an annular area between the pin and box members.

In another embodiment, these and other needs in the art are addressed by a radially expandable tubular connection. The radially expandable tubular connection includes a radially expandable tubular connection including a radially-expandable box member. The radially-expandable box member includes an internal thread and a non-threaded internal area including a dovetail groove providing a mechanical means for securing position of an elastomeric seal ring disposed in the groove. The radially expandable tubular connection further includes a radially-expandable pin member including an external thread for threadably engaging the internal thread, and a non-threaded external seal surface carried by an elongated pin nose for engaging the elastomeric seal ring in a sealable manner. The radially expandable tubular connection further includes radial expansion of the radially expandable tubular connection when the external thread is threadably engaged within the internal thread to produce deformation to compress the elastomeric seal ring between the pin and box members to seal an annular area between the pin and box members.

In other embodiments, these and other needs in the art are addressed by a radially expandable tubular connection including a radially-expandable box member. The radially-expandable box member includes an internal thread and a non-threaded internal area including a half dovetail groove providing a mechanical means for securing position of an elastomeric seal ring disposed in the groove. The radially expandable tubular connection further includes a radially-expandable pin member including an external thread for threadably engaging the internal thread, and a non-threaded external seal surface carried by an elongated pin nose for engaging the elastomeric seal ring in a sealable manner. The radially expandable tubular connection further includes radial expansion of the radially expandable tubular connection when the external thread is threadably engaged within the internal thread to produce deformation to compress the elastomeric seal ring between the pin and box members to seal an annular area between the pin and box members.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a fragmentary sectional view of a threaded box connection with a dovetail shaped groove;

FIG. 2 illustrates a cross-sectional view of an elastomeric seal ring with a dovetail shaped groove;

FIG. 3 illustrates a detailed cross-sectional view of an elastomeric seal ring with a half dovetail groove;

FIG. 4A illustrates a cross-sectional view of an elastomeric seal ring; and

FIG. 4B illustrates a side cross-sectional view of an elastomeric seal ring.

### NOTATION AND NOMENCLATURE

Certain terms are used throughout the following description and claims to refer to particular system components. This document does not intend to distinguish between components that differ in name but not function.

“Box member” refers to an end portion of a tubular member or of a coupling employing a female threadform.

“Pin member” refers to an end portion of a tubular member employing a male threadform. The threadable engagement of a pin member within a box member may be referred to as a threaded tubular connection (e.g., threaded connection, a tubular connection, or connection).

“Thread” refers to a ridge of generally uniform section in the form of a helix on the internal or external surface of a tubular member such as a pipe or a coupling.

“Tubular member” refers to a joint of pipe (e.g., a casing joint) or a coupling.

### DETAILED DESCRIPTION OF THE PREFERRED EMBODIMENTS

In an embodiment, a radially expandable tubular connection includes a box member and a pin member. The box member and pin member are radially expandable. In addition, the box member has an internal thread and a non-threaded area. The radially expandable tubular connection further includes an elastomeric seal ring carried in a specially-dimensioned groove formed in the non-threaded area of the box member. In an embodiment, the groove dimensions are designed to provide a mechanical means for securing the elastomeric seal ring in the groove during transportation and assembly of the radially expandable tubular connection. The pin member has an external thread for threadably engaging the internal thread of the box member, and a non-threaded external seal surface carried by an elongated pin nose for engaging the elastomeric seal ring in a sealable manner. In embodiments in which the external thread is threadably engaged within the internal thread, radial expansion of the radially expandable tubular connection produces deformation to compress the elastomeric seal ring between the pin member and the box member to seal the annular area between the pin member and the box member. The groove width is less than the elastomeric seal ring cross-sectional diameter in a longitudinal direction, and the groove depth is less than the elastomeric seal ring cross-sectional diameter in a radial direction. Consequently, the elastomeric ring may be securely held in the groove during transportation and assembly of the radially expandable tubular connection and may be compressed upon connection make-up and after expansion, which may provide a seal between the pin and the box members of the radially expandable tubular connection.

In some embodiments, the groove has the shape of a “dove tail” with both groove shoulders inclined to the base of the groove at angles less than 90 degrees. In other embodiments, the groove has the shape of a “half dove tail” with one shoulder inclined to the base of the groove at an angle less than 90 degrees and the other shoulder at about 90 degrees.

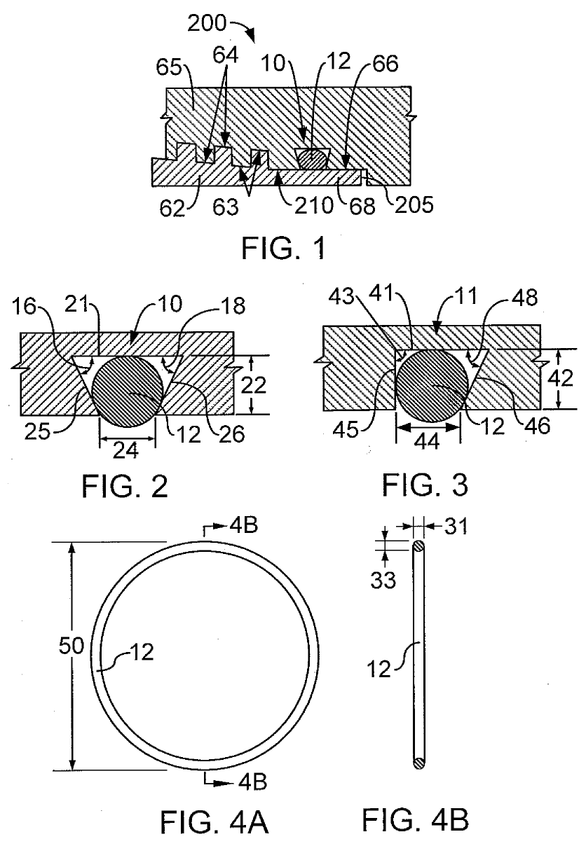

FIG. 1 shows a fragmentary sectional view of radially expandable tubular connection 200 having dovetail shaped groove 10 and elastomeric seal ring 12. Radially expandable tubular connection 200 further includes box member 65 and pin member 62. Pin member 62 has external threads 64 for threadably engaging internal threads 63 of box member 65, and elongated pin nose 68 extending between external threads 64 and free end 205 of pin member 62. Elastomeric seal ring 12 is positioned in a specially dimensioned groove, which is dovetail shaped groove 10, formed in a non-threaded area 210 of box member 65. Elongated pin nose 68 has a non-threaded external seal surface 66 that opposes the internal seal surface of elastomeric seal ring 12 for engagement therewith in a sealable manner. When external threads 64 are threadably engaged within internal threads 63, elastomeric seal ring 12 may be compressed, providing a seal between pin member 62 and box member 65 before and after radial expansion of radially expandable tubular connection 200.

The groove dimensions may be designed to provide mechanical means for securing elastomeric seal ring 12 in the groove during transportation and assembly of the connection. In an embodiment, the groove has a shape of a “dove tail,” as illustrated in FIGS. 1 and 2. FIG. 2 illustrates a detailed sectional view of dovetail shaped groove 10. Groove shoulders 25 and 26 are inclined to groove base 21 under angles 16 and 18. Both angles 16 and 18 are less than 90 degrees. Groove depth 22 is less than elastomeric seal ring cross-sectional dimension 33 (as illustrated in FIG. 4B) in the radial direction. Groove width 24 is less than cross-sectional dimension 31 of elastomeric seal ring 12. Thus, dovetail shaped groove 10 provides mechanical means for holding elastomeric seal ring 12 in dovetail shaped groove 10 during transportation and assembly of the radially expandable tubular connection 200. Elastomeric seal ring 12, positioned in dovetail shaped groove 10, provides a seal between pin member 62 and box member 65, before and after radial expansion of radially expandable tubular connection 200.

In an embodiment as illustrated in FIG. 2, groove base 21 has a diameter substantially equal to outer diameter 50 of elastomeric seal ring 12 (as illustrated in FIG. 4A). Groove depth 22 is selected in the range between about 65 and about 85 percent of elastomeric seal ring cross-sectional dimension 33 (as shown in FIG. 4B) in the radial direction. Groove width 24 is selected to be in the range from about 75 to about 90 percent of cross-sectional dimension 31 (as shown in FIG. 4B) in the longitudinal direction. Groove angles 16, 18 are selected in the range from about 60 to about 70 degrees.

FIG. 3 illustrates a detailed sectional view of the groove having a half dovetail shape, half dovetail groove 11. Half dovetail groove 11 has one groove angle 43 between shoulder 45 and groove base 41 equal to substantially 90 degrees and the other groove angle 48 between shoulder 46 and groove base 41 less than 90 degrees. Groove depth 42 is less than elastomeric seal cross-sectional dimension 33 (as illustrated in FIG. 4B) of elastomeric seal ring 12 in the radial direction, and groove width 44 is less than cross-sectional dimension 31 of elastomeric seal ring 12 in the longitudinal direction. Consequently, half dovetail groove 11 provides mechanical means for holding elastomeric seal ring 12 in the groove during transportation and assembly of radially expandable tubular connection 200. Elastomeric seal ring 12, positioned in half dovetail groove 11, provides a seal between pin member 62 and box member 65, before and after radial expansion of radially expandable tubular connection 200.

In an embodiment as shown in FIG. 3, groove base 41 has a diameter substantially equal to outer diameter 50 of elastomeric seal ring 12 (as shown in FIG. 4A). Groove depth 42 is selected in the range between about 70 and about 85 percent of elastomeric seal ring cross-sectional dimension 33 (as illustrated in FIG. 4B) in a radial direction. Groove width 44 is selected to be in the range from about 77 to about 93 percent of elastomeric seal cross-sectional dimension 31 (as shown in FIG. 4B) in a longitudinal direction. Groove angle 48 is selected in the range from about 60 to about 80 degrees, alternatively from about 60 to about 70 degrees.

It is to be understood that elastomeric seal ring 12 may be employed in various different ways. In addition, elastomeric seal ring 12 may be constructed of a suitable resilient material, such as, but not limited to, an acrylonitrile-butadiene, a fluorocarbon, a carboxylated nitrile, an ethylene acrylate, an ethylene propylene, a fluorosilicone, a hydrogenated nitrile, a perfluoroelastomes, compounds thereof, and/or combinations thereof. Elastomeric seal ring 12 may have different cross-sectional shapes. It is also to be understood that the groove may have varieties of shapes such as rounded corners or curved shoulders and/or curved groove base, provided that groove width 24 or 44 are less than cross-sectional dimension 31 in the longitudinal direction, and groove depth 22 or 42 are less than elastomeric seal ring cross-sectional dimension 33 in the radial direction, providing mechanical means for securing position of elastomeric seal ring 12 in the groove. Elastomeric seal ring 12, positioned in the groove, provides a seal between pin member 62 and box member 65, before and after expansion of radially expandable tubular connection 200.

In embodiments, a form of radially expandable tubular connection 200 may be machined on pipe where a pin connection is machined on one end of the pipe, and a box connection is machined on the other end of the pipe. Other embodiments may also be used such as the pipe being threaded with either a pin or a box on both ends and connected with pin-by-pin or box-by-box couplings. The threads may be machined with or without a taper, or there may be provided two thread steps that are radially separated. Moreover, in some embodiments, the threads may be of the “wedge thread” type, where both the stab and load flank are hooked.

Although the present invention and its advantages have been described in detail, it should be understood that various changes, substitutions and alterations may be made herein without departing from the spirit and scope of the invention as defined by the appended claims.

What is claimed is:

1. A radially expandable tubular connection, comprising:
a radially-expandable box member, comprising:
an internal thread, and
a non-threaded internal area comprising a groove providing a mechanical means for securing position of an elastomeric seal ring disposed in the groove;
a radially-expandable pin member, comprising:
an external thread for threadably engaging the internal thread, and
a non-threaded external seal surface carried by an elongated pin nose for engaging the elastomeric seal ring in a sealable manner,
whereby radial expansion of the radially expandable tubular connection when the external thread is threadably engaged within the internal thread produces deformation to compress the elastomeric seal ring between the pin and box members to seal an annular area between the pin and box members.

2. The radially expandable tubular connection of claim 1, wherein the groove comprises a groove width, and wherein the groove width is less than an elastomeric seal ring cross-sectional dimension in a longitudinal direction.

3. The radially expandable tubular connection of claim 1, wherein the groove comprises a groove depth, and wherein the groove depth is less than an elastomeric seal ring cross-sectional dimension in a radial direction.

4. A radially expandable tubular connection, comprising:
a radially-expandable box member, comprising:
an internal thread, and
a non-threaded internal area, comprising:
a dovetail groove providing a mechanical means for securing position of an elastomeric seal ring disposed in the groove;
a radially-expandable pin member, comprising:
an external thread for threadably engaging the internal thread, and
a non-threaded external seal surface carried by an elongated pin nose for engaging the elastomeric seal ring in a sealable manner,
whereby radial expansion of the radially expandable tubular connection when the external thread is threadably engaged within the internal thread produces deformation to compress the elastomeric ring between the pin and box members to seal an annular area between the pin and box members.

5. The radially expandable tubular connection of claim 4, wherein the groove comprises a groove width, and wherein the groove width is in a range from about 75 to about 90 percent of an elastomeric seal ring cross-sectional dimension in a longitudinal direction.

6. The radially expandable tubular connection of claim 4, wherein the groove comprises a groove depth, and wherein the groove depth is in a range from about 65 to about 85 percent of an elastomeric seal ring cross-sectional dimension in a radial direction.

7. The radially expandable tubular connection of claim 4, wherein groove angles between groove shoulders and a groove base are in a range from about 60 to about 70 degrees.

8. A radially expandable tubular connection, comprising:
a radially-expandable box member, comprising:
an internal thread,
a non-threaded internal area, comprising:
a half dovetail groove providing a mechanical means for securing position of an elastomeric seal ring disposed in the groove;
a radially-expandable pin member, comprising:
an external thread for threadably engaging the internal thread, and
a non-threaded external seal surface carried by an elongated pin nose for engaging the elastomeric seal ring in a sealable manner,
whereby radial expansion of the radially expandable tubular connection when the external thread is threadably engaged within the internal thread produces deformation to compress the elastomeric seal ring between the pin and box members to seal an annular area between the pin and box members.

9. The radially expandable tubular connection of claim 8, wherein the groove comprises a groove width, and wherein the groove width is in a range from about 77 to about 93 percent of an elastomeric seal ring cross-sectional dimension in a longitudinal direction.

10. The. radially expandable tubular connection of claim 8, wherein the groove comprises a groove depth, and wherein the groove depth is in a range from about 70 to about 85 percent of an elastomeric seal ring cross-sectional dimension in a radial direction.

11. The radially expandable tubular connection of claim 8, wherein one groove angle between a groove shoulder and a groove base is in a range from about 60 to about 80 degrees, and another groove angle between another groove shoulder and another groove base is substantially 90 degrees.
